(19) United States
(12) Patent Application Publication
(10) Pub. No.: US 2003/0084196 A1
(43) Pub. Date: May 1, 2003

(54) Message passing method for computer system

(76) Inventors: Cheng Tsung Chang, Taoyuan Hsien (TW); Chao Kang Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/985,106

(22) Filed: Nov. 1, 2001

(51) Int. Cl. G06F 9/46

(52) U.S. Cl. 709/313; 709/104

(57) ABSTRACT

A message passing method for computer system is proposed. The computer system comprises a common device driver unit and at least one application module unit communicated to the common device driver unit through a message exchange unit. The message exchange unit is composed of a plurality of message buffers in a plurality of tasks. Each task has an independent message buffer pointed to another task and each independent message buffer is connected to two specific tasks only. The message passed in this computer system has a lead-code, a sub-code and an extend data. The lead-code comprises a command trigger sign and a ready sign.

### FIELD OF THE INVENTION

The present invention relates to a message passing method for computer system, especially to a method for passing message among tasks of a computer system with parallel sever architecture.

### BACKGROUND OF THE INVENTION

The development of conventional operation systems and application programs are based on existing computer hardware. As the diversity of product is increased and the development term is reduced, the stress is laid on reuse of developed resource and expertise cooperation. For example, the mobile electronic device has great diversity and the architecture of the conventional operation system is not suitable for this electronic device. The development of the driver program is labor- and time-consuming job.

The inventor has developed a computer system with parallel sever architecture to overcome above problems. More particularly, this invention relates to a method for passing message among tasks of a computer system with parallel sever architecture and defining the message format.

The term “parallel” does not mean that a plurality of processors is used to execute one task. The term “parallel” means that the operation system and application program of the computer system are in parallel status, i.e., of same hierarchy. The term “sever” means that the operation system and application program of the computer system are severed and have no direct connection. The replacement of hardware and software of the computer system has no influence to the computer system. Therefore, the design flow according to the present invention is from application program to hardware and then to operation system, rather than from hardware to operation system and then to application program.

The design flow according to the present invention is client-oriented and the design effort can be reduced. The designer can choose operation system suitable to his designed application program. Therefore, the operation system is of less priority for consideration, even becomes an optional equipment. Moreover, the hardware and software of the computer system can be independently developed to save cost and time.

### SUMMARY OF THE INVENTION

It is an object of the present invention to provide a method for passing message among tasks of a computer system, wherein the operation system and application program of the computer system are in parallel status, i.e., of same hierarchy. The hardware and software of the computer system can be independently developed to save cost and time.

It is another object of the present invention to provide a method for passing message among tasks of a computer system, wherein the operation system and application program of the computer system are severed and have no direct connection. The replacement of hardware and software of the computer system has no influence to the computer system.

It is still another object of the present invention to provide a method for passing message among tasks of a computer system, which has security, anti-copying and anti-virus feature.

It is still another object of the present invention to provide a method for passing message among tasks of a computer system, which has excellent expansion ability.

It is still another object of the present invention to provide a method for passing message among tasks of a computer system, which has hardware and software with high replaceable feature. The risk of update and replacement can be reduced.

To achieve above object, the present invention provides a method for passing message among tasks of a computer system.

In one aspect of the present invention, the computer system comprises a common device driver unit and at least one application module unit communicated to the common device driver unit through a message exchange unit. The message exchange unit is composed of a plurality of message buffers in a plurality of tasks. Each task has an independent message buffer pointed to another task and each independent message buffer is connected to two specific tasks only. The message passed in this computer system has a lead-code, a sub-code and an extend data. The lead-code comprises a command trigger sign and a ready sign.

In another aspect of the present invention, the message passing method for computer system comprises following steps: (a) a task A sending a message to a first memory block of a memory unit in the computer system through a send buffer thereof; the first memory block being write only to the task A; (b) a task B receiving the message from the first memory block of the memory unit through a receive buffer thereof; the first memory block being read only to the task B; (c) the task B executing a specific job according to the message; (d) the task B sending a message to a second memory block of a memory unit through a send buffer thereof; the second memory block being write only to the task B; and (e) the task A receiving the message from the second memory block of the memory unit through a receive buffer thereof; the second memory block being read only to the task A.

In still another aspect of the present invention, the message comprises at least a lead-code used in acquisition of system resource and system setting, a sub-code used as extension code of the lead-code, and an extend data used to indicate the length and content of a data contained in the message instruction. The lead-code comprises a command trigger sign used to indication updating of message instruction; and a ready sign used to indicate the completeness of the message instruction.

The various objects and advantages of the present invention will be more readily understood from the following detailed description when read in conjunction with the appended drawing, in which:

### BRIEF DESCRIPTION OF DRAWINGS

FIG. 1 shows a schematic diagram of the computer system according to the present invention;

FIG. 2 shows a block diagram for demonstrating the transmission of message in the present invention;

FIG. 3 shows a flowchart of message interchange between two tasks;

FIG. 4 demonstrates the switching of task in the present invention;

FIG. 5 shows the format of the message instruction; and

FIG. 6 shows the internal structure of the message instruction of the present invention.

### DETAILED DESCRIPTION OF THE INVENTION

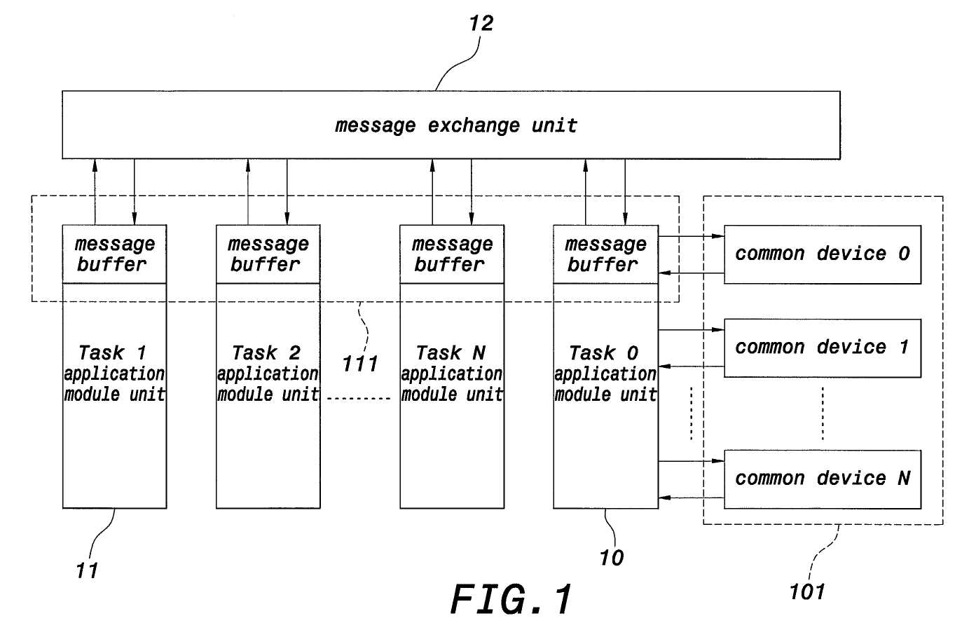

As shown in FIG. 1, the computer system used to demonstrate the method of the present invention has parallel sever architecture and mainly comprises CPU, memory and I/O interface. The computer system further comprises a common device driver unit 10 for managing the I/O interface of a plurality of common devices 101 of the computer system, at least one application module unit 11 runnable on the computer system and comprising hardware and software to perform certain function with the help of the common device 101 in the common device driver unit 10, and a message exchange unit 12 functioned as message interface of the common device driver unit 10 and the application module unit 11. In the present invention, the common device driver unit 10 and the application module unit 11 are in parallel status. Moreover, the common device driver unit 10 and the application module unit 11 are severed and have no direct connection. The communication between the common device driver unit 10 and the application module unit 11 is controlled by the message exchange unit 12 rather than conventional functional call. Moreover particularly, the common device driver unit 10 severs as a service task of the common devices 101 and provides specific function with the help of the application module unit 11. Therefore, the hardware and software of the computer system can be developed in modularized fashion and the allocation of system resource is not important problem.

The tasks in the inventive computer system communicate to each other through the message exchange unit 12. The message exchange unit 12 is implemented by a plurality of message buffers 111 in each of the tasks. Moreover, the plurality of message buffers 111 can be integrated to form an integral memory. However, the message buffer 111 in the present invention is different to the message buffer in conventional computer. More particularly, in the present invention, the task reads data from a reading address of the message buffers 111 and writes data to a writing address of the message buffers 111. The reading address and the writing address of the message buffers 111 are the same logical address. However, the reading address and writhing address are different physical address, i.e., in different memory blocks.

Each task in this system recognizes only two fixed task messages. The first task message is provided by the service task, which is the task 0 of this system. The application module unit 11 learns about the services provided by the service task when it is initialized. Therefore, the application module unit 11 can provide specific function with the help of the service task. The second fixed task message is a written by the task into the message buffer 111 and is visible to other tasks.

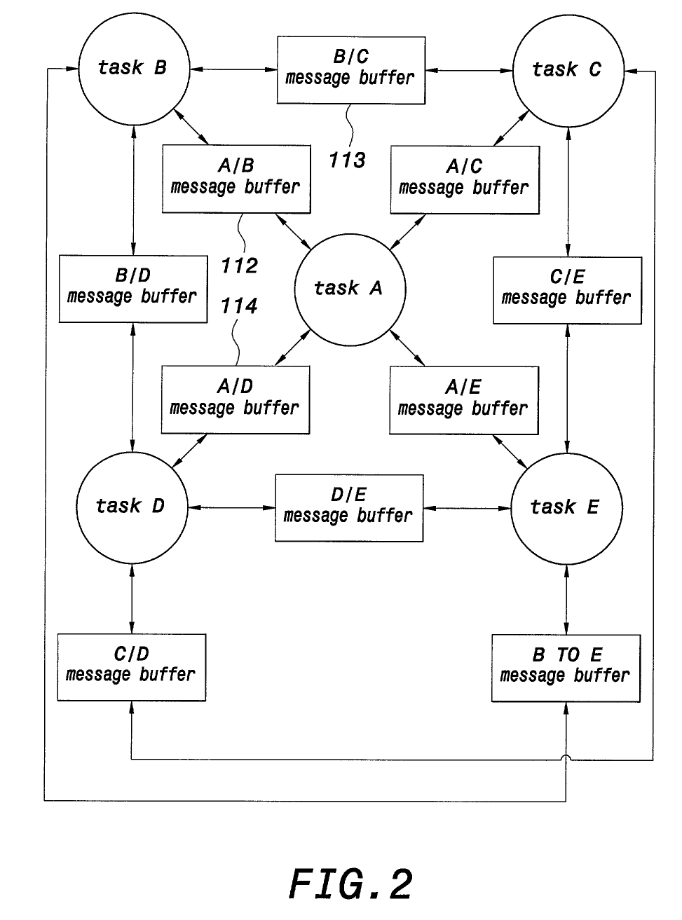

FIG. 2 shows a block diagram for demonstrating the transmission of message in the present invention. In this invention, each task sent message to another task through a message buffer 111 pointed to a specific task, wherein the message buffers 111 are pointed to different task. For example, a task A has a sixth task 112 pointed to a task B and the sixth task 113 of the task B is pointed to the task C. This is a special design to prevent illegal jumping of message. Therefore, a mesh of message buffers 111 is required to provide message interchange. FIG. 2 shows four tasks (task A, task B, task C and task D) and each of the tasks has a respective message buffer 111 pointed to another task. Moreover, each message buffer 111 is linked to two respective tasks. The data in each message buffer 111 has only unidirectional transmission in those links and cannot be accessed by other tasks not linked to the message buffer 111. The number of the message buffers 111 is increased when the number of the tasks is increased. However, this approach provides better protection to data.

By above mechanism, the data in the message buffers 111 may have not fixed address. For example, if the task A receives a message from the third message buffer 114 thereof, the message can be originally sent from the task D, the task E or other task. Moreover, if the task D sends message to the task A, it may send data through the fifth message buffer 114 thereof. Therefore, it is hard for hacker to user jumping program to hack data.

For example, the jumping program will place certain program code in the message buffer 111 and then the computer system is switched to another task by the jumping program. Afterward, the program code is executed by interrupt or other way to steal data or program from this task and the data and program is modified or copied. Therefore, the data and program cannot be protected. On the contrary, the variable address scheme in the message buffer 111 will hinder the jumping action of the jumping program. Therefore, hacker cannot intrude other task and read data from other task. Similarly, virus can also be protected.

In the present invention, the application module unit 11 can send program to the common device driver unit 10 and the program is executed in the common device driver unit 10. More particularly, the program is not binary code but script code, which is an interpret language. The application module unit 11 uses a script bin program transferred from the script code. The script bin program executes certain operation in the common device driver unit 10 for the application module unit 11. If a task receives an executable program from another task, the task will not perform the executable program unless the executable program is a script bin program. The script code will not be harmful to the computer system.

The present invention does not provide encryption mechanism to hardware architecture. The communication in the hardware architecture has unique source and destination. For example, the task C will not be aware of the message interchange between the task A and the task B. The message buffer 111 will not send the message interchange between the task A and the task B to the task C or through the task C. In other ward, the message interchange between two tasks is isolated from the other tasks and the present invention provides inherent security in hardware level.

The inherent security in hardware level is advantageous to data and application-program company. A task is not aware of the message interchange between two other tasks and the coping action can be prevented. Furthermore, the message buffer 111 can have memory implemented by chip. Therefore, the data stored in the memory cannot be stolen by intruding core or hacking.

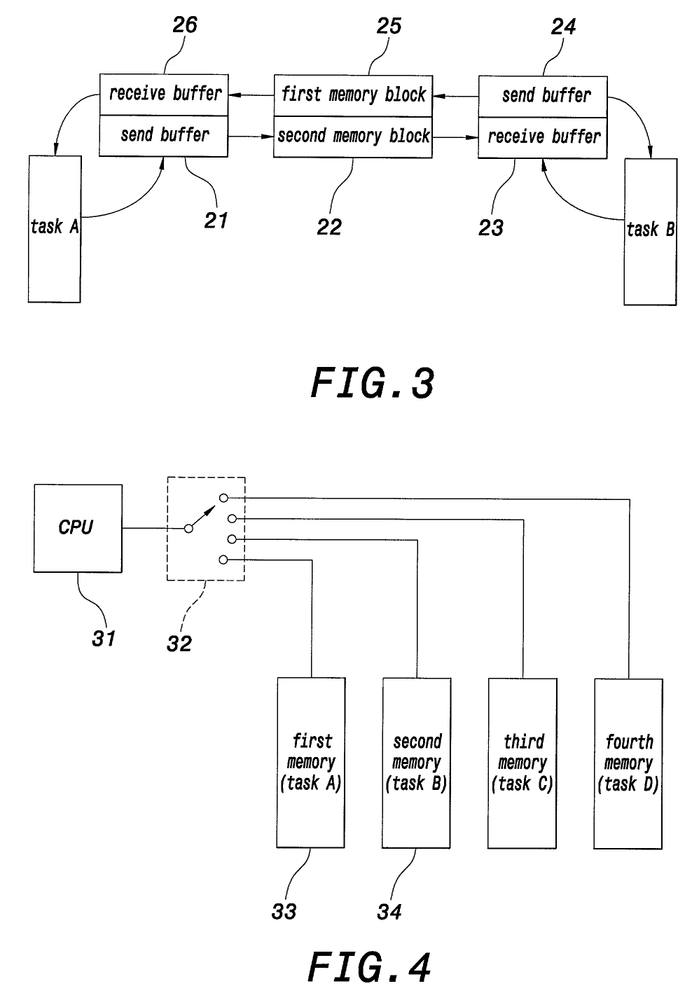

FIG. 3 shows a flowchart of message interchange between two tasks A and B, which is achieved by the message exchange unit 12.

In this example, there are two tasks A and B. The task A sends a message to the task B and the task B replies a message to the task A after proper processing by following steps:

Step 1: the task A sends a message to a second memory block 22 of the memory unit 2 through a send buffer 21 thereof.

Step 2: the task B receives the message from the task A through the second memory block 22 of the memory unit 2 and the receive buffer 23 thereof. The second memory block 22 is write only for the task A and read only for the task B.

Step 3: the task B process the message from the task A and a message containing the processing result is stored in the send buffer 24 of the task B. The memory block corresponding to the send buffer 24 of the task B is a first memory block 25, which is write only for the task B and read only for the task A. From the viewpoint of the task B, the first memory block 25 is the receive buffer 26 of the task A.

Step 4: the task A receives message of the task B from the first memory block 25 and through the receive buffer 26 thereof, thus completing the message interchange process.

As to the send buffer of the task A, the second memory block 22 is write only for the task A and used as a data storage unit of the task B. As to the receive buffer of the task B, the second memory block 22 is read only for the task B and used to receive data from the task A. As to the send buffer of the task B, the first memory block 25 is write only for the task B and used as a data storage unit of the task A. As to the receive buffer of the task A, the first memory block 25 is read only for the task A and used to receive data from the task B.

As can be seen from above description, a memory block provides a specific function for one task, i.e., read only function for one task and write only function for another task and one task cannot simultaneously read from and write to a memory block. In other word, one task cannot read data from a memory block into which it writes data and cannot write data into a memory block from which it reads data. In the computer system according to the present invention, the communication between tasks and the communication between service task and user task is similarly in simplex fashion. Moreover, the display and keyboard are also executed by the service task through the communication of the message exchange unit 12 or by the user task through the communication of the message exchange unit 12.

The present invention provides a simplex communication and double buffer scheme for each task to block the intruding of hacker. More particularly, there are two kinds of transmitted messages in the present invention. The first kind is message exchanged between tasks and the second kind is message sent by the service task to all other tasks or a specific task. The second kind of message is event-driving paradigm. That is, the common device driver unit 10 generates a specific message to the application module unit 11 when user has key-pressing, key-releasing, timing, monitor refreshing or interrupt operations.

The event-driving paradigm is extensively used in operation systems and the present invention also uses event-driving paradigm in the architecture of the message exchange unit 12. The system developer can choose to use single message exchange wherein the message buffer releases a memory block to the event-driving program. Alternatively, the system developer uses two message buffers wherein one message buffer is used as ordinary message buffer and another message buffer is used as message buffer for event-driving program. Alternatively, there is only message buffer for event-driving program.

FIG. 4 demonstrates the switching of task in the present invention. The present invention provides a computer system with parallel sever architecture wherein the memory is switched with task. As shown in this figure, the CPU 31 is provided with a selection switch 32 for task selection. For example, the selection switch 32 is switched to the position of a first memory 33 if a task A is to be executed. The selection switch 32 is switched to the position of a second memory 34 if a task B is to be executed. Moreover, the I/O address is also switched with respect to the task to prevent detection by hacker. Furthermore, other switching method can also be used as long as the address of the message buffer 111 and the characteristics of the message buffer have been taken into account.

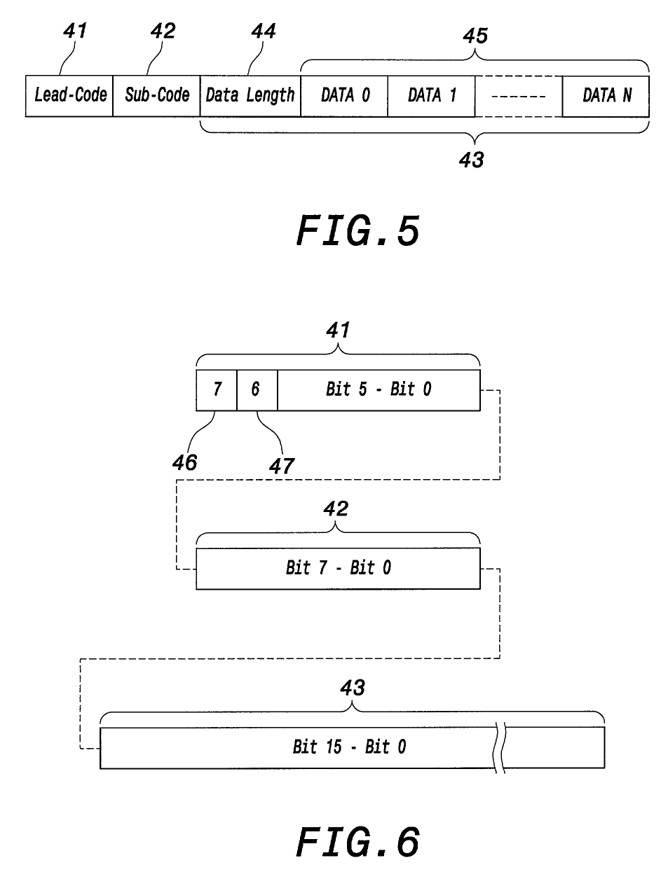

FIG. 5 shows the format of the message instruction, which may contains data of various amount. The message instruction contains a lead-code 41, a sub-code 42 and extend data 43. The extend data 43 includes a data length section 44 and data content 45. The message instruction may have various formats. In a first format of the message instruction, the message instruction is a prompt instruction and contains only the lead-code 41. This instruction is often used in acquisition of system resource and system setting. In a second format of the message instruction, the message instruction contains the lead-code 41 and the sub-code 42, wherein the sub-code 42 is used as extension code of the lead-code 41 and provides more advanced function for the message instruction. In a third of format of the message instruction, the message instruction comprises the lead-code 41, the sub-code 42 and the extend data 43, wherein the extend data 43 can be string, graphic or other data. The message instruction in the present invention can be achieved in above-mentioned three formats.

When a first task has a request to a second task (user task or a service task), the first task sends a message instruction containing this request to the second task and the second task replies a message instruction containing requested data to the first task. The message instruction of the present invention has simple format that modularization of the computer system including the operation system can be achieved. The service task can be programmed in to a CPU, a DSP or a RISC CPU because both data and instruction can be transmitted through the formatted message instruction. The operation system for service task can be implemented in different hardware as long as the message instruction has above-mentioned format. The message instruction according to the present invention can be applied to CPU of different instruction set. Therefore, the development effort can be laid on functionality rather than type of CPU. Therefore, the service task can be executed by RISC, MCU, CPU or DSP.

FIG. 6 shows the internal structure of the message instruction of the present invention. When a task read message from a memory block, the task cannot delete data in this memory block because the memory block is read only to this task. Moreover, it is also hard for this task to judge whether the message is an old command or a new command. This is a side effect of the isolation design in the present invention. To overcome this problem, the present invention provides two bits of data in the message instruction to represent the condition of command updating. The two bits of data are command trigger sign 46 and ready sign 47, respectively.

When the command is updated, the command trigger sign 46 is inverted. In other word, if the command trigger sign 46 is 0 for current command, the command trigger sign 46 will become 1 for next command. Moreover, if the command trigger sign 46 is 1 for current command, the command trigger sign 46 will become 0 for next command. Each task including the service task can judge the validation of command through tracking the value of the command trigger sign 46. In the present invention, the command trigger sign 46 is designed as first bit in the lead-code 41 for facilitating comparison and programming.

The ready sign 47 is set to 1 when the message sent from another task is not complete. Therefore, the received message will not be executed when the ready sign 47 is 1, even though the command trigger sign 46 indicates that the command is updated. At this time, the task for sending message is not ready. After the ready sign 47 is set to 0, the received message is executed. The present invention employs the command trigger sign 46 and the ready sign 47 to ensure the validation and completeness of message instruction. In practical, the lead-code 41 is added last to the message instruction after the sub-code 42 and the extend data 43 are finished.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A message passing method for computer system, comprising following steps:
(a) a task A sending a message to a first memory block of a memory unit in the computer system through a send buffer thereof; the first memory block being write only to the task A;
(b) a task B receiving the message from the first memory block of the memory unit through a receive buffer thereof; the first memory block being read only to the task B;
(c) the task B executing a specific job according to the message;
(d) the task B sending a message to a second memory block of a memory unit through a send buffer thereof; the second memory block being write only to the task B;
(e) the task A receiving the message from the second memory block of the memory unit through a receive buffer thereof; the second memory block being read only to the task A.

2. The message passing method for computer system as in claim 1, wherein the first memory block and the second memory block belong to the same memory unit, each memory block is read only for one task and write only for another task, one task cannot read and write the memory block simultaneously.

3. The message passing method for computer system as in claim 1, wherein there are two kinds of messages transmitted between tasks, one is a message exchanged between tasks and another is an event-driving message sent by a common device driver unit to all other tasks or a specific task.

4. A message instruction for a computer system, the message instruction comprising at least:
a lead-code used in acquisition of system resource and system setting and being a prompt instruction.

5. The message instruction for a computer system as in claim 4, wherein the lead-code comprises
a command trigger sign used to indication updating of message instruction; and
a ready sign used to indicate the completeness of the message instruction.

6. A message instruction for a computer system, the message instruction comprising at least:
a lead-code used in acquisition of system resource and system setting, and
a sub-code used as extension code of the lead-code and providing more advanced function for the message instruction.

7. The message instruction for a computer system as in claim 5, wherein the lead-code comprises
a command trigger sign used to indication updating of message instruction; and
a ready sign used to indicate the completeness of the message instruction.

8. A message instruction for a computer system, the message instruction comprising at least:
a lead-code used in acquisition of system resource and system setting, and
a sub-code used as extension code of the lead-code, and
an extend data used to indicate the length and content of a data contained in the message instruction.

9. The message instruction for a computer system as in claim 8, wherein the data is string or graphic.

10. The message instruction for a computer system as in claim 9, wherein the lead-code comprises
a command trigger sign used to indication updating of message instruction; and
a ready sign used to indicate the completeness of the message instruction.

11. A computer system comprising CPU, memory and I/O interface, the computer system further comprising a common device driver unit and at least one application module unit; the common device driver unit and the application module unit being tasks of parallel status; the common device driver unit and the application module unit being severed and having no direct connection; a message exchange unit functioned as message interface of the common device driver unit and the application module unit; the message exchange unit being composed of a plurality of message buffers in each of the tasks; each task having an independent message buffer pointed to another task and each independent message buffer connected to two specific tasks only.

12. The computer system as in claim 11, wherein the application module unit sends a program to the common device driver unit for operation, the program is a script bin program transferred from a script code, the common device driver is designed to perform only an executable script bin program.

13. The computer system as in claim 11, further comprising a selection switch connected between the CPU and each task.
